(19) United States
(12) Patent Application Publication
(10) Pub. No.: US 2023/0247978 A1
(43) Pub. Date: Aug. 10, 2023

(54) Method and System for an Insect Killer Drone

(71) Applicant: Amos Azaria, Pittsburgh, PA (US)

(72) Inventor: Amos Azaria, Pittsburgh, PA (US)

(21) Appl. No.: 18/068,686

(22) Filed: Dec. 20, 2022

Related U.S. Application Data
(60) Provisional application No. 63/267,600, filed on Feb. 6, 2022.

(51) Int. Cl. A01M 5/02; A01M 27/00; B64U 20/70

(52) U.S. Cl. CPC A01M 5/02; A01M 27/00; B64U 20/70; A01M 2200/012; B64U 2101/00

(57) ABSTRACT

Due to their disease transmission, mosquitoes are the deadliest animal, killing over a million people each year. In addition, mosquitoes cause discomfort for adults and especially children who may suffer heavily from mosquito bites. Indeed, a study shows that most respondents considered mosquitoes to be a problem. Unfortunately, a combination of environmental change and urbanization help mosquitoes spread into new areas. Spraying mosquito repellent to eliminate mosquitoes was shown to be harmful for humans as well, and other devices fail to eliminate all mosquitoes. Therefore, we propose the development of an insect killer drone. The drone will include a tiny gun that, once the drone approaches the mosquito, will be able to eliminate it. The system also includes a docking station that detects the mosquitoes and controls the drone. The drone is intended to be autonomous but may allow manual control of the drone and tiny gun.

### FIELD

This invention is in the field of pest control and drones. More specifically the use of a drone for pest control including mosquito elimination. This invention may also be relevant to the field of entertainment.

### BACKGROUND OF THE INVENTION

Due to its disease transmission, the mosquito is the deadliest animal killing over a million people each year who die from mosquito borne diseases such as Malaria. Mosquitoes cause discomfort for adults and especially children who may suffer heavily from mosquito bites. A combination of environmental change, urbanization and human movements around the world are helping mosquitoes spread into new areas, according to the findings reported in the journal Nature Microbiology. In a study in two counties of New Jersey, it was found that the majority (54.6%) of respondents considered mosquitoes to be a problem. Out of which 30.6% rated mosquitoes as a moderate problem, 12.4% as a severe one, and 11.6% as an extremely horrible one. 80.2% of respondents reported being bitten at least once a week, with 23.1% bitten while indoors. Another study in Wisconsin concluded that residents might be willing to pay on average $147 per household per year to reduce mosquito nuisance. Mosquitoes are very fast, and it is very difficult to intercept their flight. However, they often settle down in a specific place without moving and can be eliminated in that location.

Currently, there are several methods for mosquito elimination, including spraying mosquito repellent, electric mosquito killer and zapper. However, spraying against mosquitoes was shown to be harmful for humans and other animals. Other devices fail to catch all mosquitoes. There have been some attempts for hitting mosquitoes with laser beams from a distance; however, laser beams strong enough to kill mosquitoes from a distance are harmful for humans as well, especially if hitting an eye.

Recently, commercial drones have become very popular and useful in many different scenarios. In addition, the advances in artificial intelligence have allowed the detection of many different objects, which may be used to detect harmful insects as well as humans and pets. However, currently, no drone includes a tiny gun for eliminating mosquitoes or any insects.

### BRIEF SUMMARY OF THE INVENTION

The development of a system for an insect killer drone with a tiny gun. The drone will include a component that will detect the mosquitoes (or other insects), and a gun that, once the drone approaches the mosquito, will be able to eliminate it. The system will also include a docking station. The system is intended to be autonomous but may allow manual control of the drone with the tiny gun. FIG. 1A presents the different components of the system. Everything in this manuscript can be used for any other insect, bug, or object (e.g., flies). The drone may be replaced with any AUV. The drone with a tiny gun may also be used for entertainment purposes with manual control.

### BRIEF DESCRIPTION OF THE SEVERAL VIEWS OF THE DRAWING

FIG. 1A presents the different components of the system.

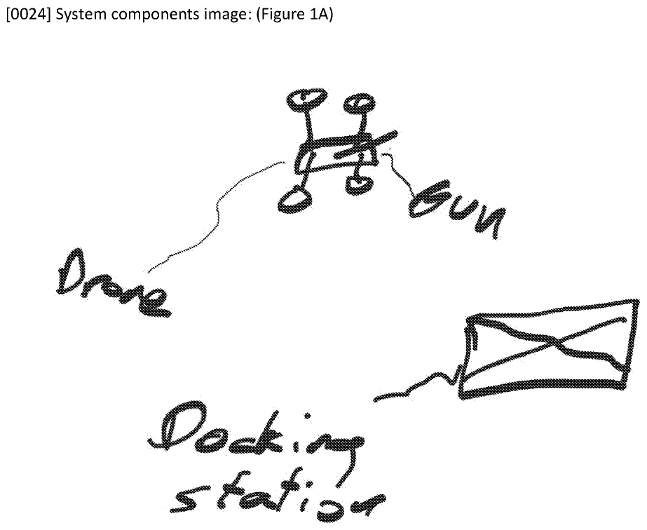

### DETAILED DESCRIPTION OF THE INVENTION

The system is composed of the following: a drone with an insect killing component (gun), which flies near the detected insect and kills it using the gun; an insect detector and drone controller, which detects the insects and controls the drone; and a docking station, which can charge the drone. All components may have small computers on them (e.g., Arduino or raspberry pi) and connect to the network (via Wi-Fi, Bluetooth, etc.). The system is intended to be fully autonomous but may instead or in addition allow manual control of the drone with the tiny gun.

The docking station includes a computer, a camera, and a charger for the drone (which connects to it automatically from below, and autonomously flies back once it needs to be recharged). The docking station is used for scanning for mosquitoes, for directing the drone to the target, and charging it with electricity and adding ammo if required. The system also includes a drone which includes a tiny gun (or strong laser beam etc.) for flying next to a mosquito and shooting it, the drone has a small computer on it for operating it, as well as the shooting component (can be Arduino or similar); it can receive commands from the docking station. The shooting component on the drone may have its own controller/computer, which will be mounted on the drone.

The drone can either scan for mosquitoes itself or be autonomously operated only once the docking station detects a mosquito. Either way, the drone automatically returns to the docking station, to be charged, when power is low, and is charged automatically. We will consider a setting of charging in a square with ‘+’ at diagonals and ‘−’ at the opposite corners, such that the drone can land on the charger in any direction and still be charged.

Running a survey for estimating the use of the system may be done with or without priming. Priming includes mosquitoes being dangerous as disease transmitters and the mentioning of children. Priming may also mention a robot vacuum cleaner, questioning the subjects what is more important to them, and how much did they pay on the robot vacuum cleaner.

One might consider the use of near infrared for detecting mosquitoes (as used in surveillance cameras), or shine light beam (LED), though it may disturb the users. Once detecting a target and flying the drone, if using IR, the drone might also need visible light so it can be seen by the users. Note that the drone makes noise when it flies, which may anyway disturb the users and be used as an alert.

The system can use YOLO or similar object detection methods to identify mosquitoes (or flies, etc.). Classification can be performed on the docking station, on the drone, or in the cloud. Classes may include insect (fly, mosquito, etc.), spot (including hole, mark, dirt, etc.), dead mosquito, live mosquito. The system could also detect the type of each mosquito, such as Aedes, Culex, biting midges (or fly etc.), as different mosquitoes may be more susceptible to transmit diseases. The type of mosquito also determines its size, which impacts the computation of distance to the target based on the image. Some types may also behave differently with respect to the drone, and some may be larger and require different ammo (or etc.) to be killed. Some mosquitoes (and similar insects) do not bite, such as, non-biting midges and crane flies; the user may elect not to eliminate them. We will also use object detection for people, cats, and dogs (to avoid flying near them, or possibly avoid operating when around). Our dataset will also include negative samples. We may consider using classical segmentation (like in R-CNN) for assisting in labeling. Data augmentation: We might add white background (or different wall backgrounds) to images with mosquitoes at different places (and compute the new bounding box accordingly), as well as classical data augmentation such as stitching together multiple images and rotating them. We may also add data by converting colored images into infra-red images using an autoencoder/cycle VAE/cycle GAN etc. Since mosquitoes may compose only a small portion of an image, the model might need to be trained on a relatively high resolution (e.g., 1024), and in inference time, if the model does not find any mosquito in the entire (scaled down) image, the image might be split into 4 images or so (possibly overlapping), each being fed into the model. Depending on the camera resolution, the image may be future split if nothing is found. It is also possible to perform a fast scan without splitting images, and if nothing is found, perform a slower scan. Furthermore, maybe closer areas don't need to be split, but further-away areas do.

The system remembers where there were mosquitoes and may avoid sending the drone to the same place again and again (as it most likely is not a live mosquito). It uploads important recognitions to the cloud for improving training. The docking station (or drone) can possibly have a zoom in its camera, or a separate camera for testing suspicious objects (with a low threshold). Laser (possibly in IR) LiDAR may be used to detect the distance to the object. We are likely to use a moving camera (pan-tilt) and use multiple images to detect the distance, like using dual cameras (or according to mosquito size, at least for an initial estimate). In general, the drone learns from coming closer to an object whether it is a mosquito/fly etc. During its flight the drone (or docking station) can compare the original image with the current view to ensure that it reaches the target.

A side note that mosquitoes are common in the summer. This means that most sales should be in the summer. This is also an opportunity to encourage people to buy (the summer is approaching), but also the surveys should be conducted during that period.

The system will allow multiple docking stations (possibly one for each room), connecting via Wi-Fi (Bluetooth or similar). Each docking station can have a moving camera (possibly similar to the one on the drone). Not all docking stations need to have a computer on them (e.g., raspberry pi), as one docking station can do all the computations, and the others only need a Wi-Fi connection to send/receive the information (e.g., images). Each docking station can be used as a charging base for the drone. Alternatively, the drone can search all the house for mosquitoes itself, (possibly communicating with a single docking station, with a computer). Another option is for the drone to find a place in each room to rest and scan it for mosquitoes.

Possibly, the docking station can compare its image from the images obtained from the drone, until it matches and then the drone can fly toward the target, which should result in enlarging the image (detected as a mosquito).

The system will be tied to an app on a phone, to which it will report finding mosquitoes (along with the mosquito type, or other insects), killing mosquito attempts and results.

The shooting can use air pressure, a spring, or rubber-bands. If using a spring, the tiny gun can apply an AEG (Electric Airsoft Guns) mechanism, with the trigger being pulled electronically (e.g., by using a small motor). If using air pressure, a pump can create pressure inside a small tube, or a very small pressure-bottle cylinder may be used (co2). The pressure is released at once using a solenoid valve usually closed. The ammo is sand/salt or similar. The barrel might be flexible so that the drone can aim it at the mosquito. Otherwise, it might need to position itself in a way that it can shoot the mosquito, but it might make it difficult for treating both ceilings and walls, so there must be at least two options for shooting, one above the drone, and the other to the side. The docking station can track the drone during its flight and confirm whether there was a hit or a miss. This information can be reported back to the user. In addition, the information can be used as a reward signal to train a reinforcement learning agent, so that the system adapts its behavior, shooting and approaching technique, according to the result. It may be possible to zap the mosquito, suck it (possibly using the drone's rotors), or shoot a sticky tongue-like object at them. The small tube may be filled with air at the docking station (to avoid carrying the air pump on the drone).

The system may allow a user to point at a mosquito (or another target) using a laser or a similar beam. This can help in case that the system does not recognize a mosquito. The small dedicated remote controller beam may be sold separately, or the system may allow the user to use any laser, possibly requiring it first to be registered with the system, with a process requiring the user to point the laser at some specific point.

The system may allow a speech UI installed directly on the docking station (or on the drone). The system may talk when detecting a mosquito and when it is about to launch the drone. It may also obtain commands from the user. The system will also have an app on the phone for a graphical user interface.

Mosquitoes seem to not be bothered by the drone wind or its noise. Might depend on mosquito types. Might be different for other insects and might change if the mosquitoes learn to recognize the drone sound/wind. However, many animals catch mosquitoes by first moving close to them and then eating them quickly (with a fast tongue or similar), so this problem is very likely to be solvable.

System usage may include private homes, restaurants, event halls, etc. Outdoor usage is much more complicated but can be targeted as well.

A drone with a tiny gun or a laser beam may also be used for entertainment purposes for example for a multiple player game in which each player controls a drone and they may shoot each other's drone or person to eliminate from the game. The drone with the tiny gun will be manually operated to that end. Clearly, the ammo and shooting power must be adapted for entertainment use.

1. An invention of a system of an insect killer drone comprised of:
a drone with an insect killing component;
an insect detector and drone controller; and
a docking station.

2. The said insect detector and drone controller of claim 1 attached to the drone, a part of the docking station, or both.

3. All said system components of claim 1 including a small computer (e.g., Arduino or Raspberry Pi), and connected to the internet (via Wi-Fi, Bluetooth, etc.).

4. The said insect detector and drone controller of claim 1 detecting whether the said drone with an insect killing component succeeded in killing an insect or not.

5. The said drone of claim 1 autonomously returning to the said docking station for recharging and when idle.

6. The said system of claim 1 comprised of multiple said docking stations, multiple said insect detector and drone controller, or multiple drones.

7. The said insect killing component of claim 1 applying an Electric Airsoft Gun (AEG) mechanism, with the trigger being pulled by a computer command, which may control a small motor or a different electrical method for pulling the trigger to shoot the ammo.

8. The said insect killing component of claim 1 using air pressure by a pump that creates pressure inside a small tube, or by using a cylinder manufactured with high pressure and a solenoid valve for releasing pressure at once to shoot the ammo.

9. The said insect killing component of claim 1 using sand or salt as ammo.

10. The said insect killing component of claim 1 with a flexible barrel for aiming at the insect.

11. The said insect killing component of claim 1 using an electric shock for killing an insect.

12. The said insect killing component of claim 1 using a laser beam for killing an insect.

13. The said insect killing component of claim 1 using a sticky item (e.g., tongue) for killing an insect.

14. The said insect killing component of claim 1 using a suction mechanism (e.g., using its rotors) for killing an insect.

15. The said system of claim 1 further comprised of a user input/output component, using speech input/output, visual input/output, or both.

16. The said system of claim 1 connected to a user app for providing input/output as per claim 15.

17. The said system of claim 1 enabling a user to point at a target to be eliminated (e.g., using a gesture, a laser beam, or a dedicated device).

18. The said system of claim 1 detecting animals and humans, which should be avoided and unharmed.

19. The said system of claim 1 using deep learning and/or reinforcement learning for training and improving its performance.

20. A said drone with an insect killing component of claim 1 used for entertainment purposes.
